(19) United States
(12) Patent Application Publication
(10) Pub. No.: US 2025/0392825 A1
(43) Pub. Date: Dec. 25, 2025

(54) CALIBRATION AND METHODS FOR RGB-IR HDR IMAGING SYSTEMS

(71) Applicant: AyDeeKay LLC dba Indie Semiconductor, Aliso Viejo, CA (US)

(72) Inventors: Hongxin Li, Aliso Viejo, CA (US); Peng Lin, Aliso Viejo, CA (US); Manjunath Somayaji, Aliso Viejo, CA (US)

(73) Assignee: AyDeeKay LLC dba Indie Semiconductor, Aliso Viejo, CA (US)

(21) Appl. No.: 19/246,605

(22) Filed: Jun. 23, 2025

Related U.S. Application Data
(60) Provisional application No. 63/663,665, filed on Jun. 24, 2024.
(60) Provisional application No. 63/664,384, filed on Jun. 26, 2024.

(51) Int. Cl. H04N 23/71; H04N 23/741

(52) U.S. Cl. CPC H04N 23/71; H04N 23/741

(57) ABSTRACT

A technique for calibrating an RGB-IR sensor includes identifying IR crosstalk coefficients for each of an R, G, and B color signal by taking calibration measurements under multiple lighting conditions. The calibration measurement may be taken in a presence of infrared light and without infrared light. Moreover, the calibration measurement may be taken under N lighting conditions, as M images of neutral flat surfaces of a color checker. The resulting coefficients may be used in determining a color correction matrix for a camera with the RGB-IR sensor.

### CROSS REFERENCE TO RELATED APPLICATIONS

This application claims priority under 35 U.S.C. 119(e) to: U.S. Provisional Application Ser. No. 63/664,384, entitled “An RGBIR Sensor-Based HDR Imaging System,” by Hongxin Li, et al., filed on Jun. 26, 2024; and U.S. Provisional Application Ser. No. 63/663,665, entitled “RGB-IR Camera Color Matrix Calibration Method, and an IR Crosstalk Removal Method for RGB-IR Camera,” by Hongxin Li, filed on Jun. 24, 2024, the contents of both of which are herein incorporated by reference.

### FIELD

The present disclosure relates to techniques for imaging using a camera sensor, such as

a Red-Green-Blue-infrared (RGB-IR) sensor.

### BACKGROUND

Conventional RGB cameras use distinct pixel types, e.g., red (R), green (G), and blue (B), to capture visible light and produce full-color images. RGB-IR cameras extend this capability by integrating an additional pixel type specifically sensitive to infrared (IR) light. These sensor architecturee enable the simultaneous capture of both visible light (typically ˜380-750 nm) and infrared light (typically ˜780 nm-1 mm). Consequently, RGB-IR cameras combine the benefits of standard RGB imaging, which provides essential color information, with the unique advantages of IR imaging. IR imaging facilitates applications such as surveillance and driver monitoring by enabling reliable, around-the-clock operation under non-visible illumination, thereby avoiding unnecessary attention. However, a key technical challenge arises during image capture: IR light incident on the RGB pixels can distort their output signals, a phenomenon known as ‘IR crosstalk’. This inherent characteristic typically necessitates specialized processing, but underscores the growing significance of RGB-IR technology in advanced imaging applications.

The high-quality calibration for color-correction matrices is typically desirable for accurate color reproduction. In common practice, the color vector C=(R, G, B) that best represents the color of a camera shooting target is inferred by multiplying the 3-by-N color-correction matrix M with the N-dimension color vector S=(S₁, S₂, . . . , Sₓ) detected by the camera sensor, in which N is the number of color channels available from the camera sensor. The color-correction matrix calibration process may find multiple color-correction matrices M corresponding to different illuminants of interest, and each M may minimize the total color error between the color vector C and the ground-truth R, G, and B values for a group of known color patches under one illumination.

While proprietary calibration techniques have been developed for RGB cameras to overcome local optima and flaws in publicly available color perception models, directly applying a color-correction calibration for RGB cameras to the R, G, and B channels of an RGB-IR camera typically does not yield perceptually acceptable results. For example, the R, G, and B channel data of a typical RGB-IR camera has crosstalk components from IR light that interfere with the color-correction process if not specially handled.

Moreover, High Dynamic Range (HDR) image processing is a technique used to enhance the range of brightness levels (such as Dynamic Range) in a photograph. Traditional photography captures a limited range of light, which can result in a loss of detail in the brightest and darkest areas of an image. HDR processing addresses this limitation by combining multiple exposures of the same scene, each taken at different exposure levels. These images are then merged to create a single image that includes details in the dark and bright portions. The result is a photograph that provides more detail than an image captured from a single exposure.

In practice, the process of creating an HDR image involves several operations. First, a series of images is captured. These shots capture the scene at various exposure levels, from underexposed to overexposed. Stated differently, some images have a longer exposure time, increasing the detail in the dark parts of the image, and some images have a shorter exposure time, increasing the detail in the bright parts of the image. Next, these images are aligned and merged, which maps the range of luminance values from the combined exposures into a single image. This merging process involves techniques that balance the varying light intensities to prevent ghosting and other artifacts. Moreover, color mapping is applied to adjust the image for display on standard monitors or prints, ensuring the enhanced dynamic range is effectively rendered. The result is typically an image with richer colors, improved contrast, and greater depth, offering a more immersive viewing experience.

When a camera captures an image, the information from each color pixel may not directly represent the actual strength of that color as viewed by the human eye because the pixels often have different relative sensitivities. Therefore, it is generally desirable to perform a calibration of a camera sensor to adjust for these differences in sensitivity. Additionally, calibration may also offset other phenomena that cause a distorted image. When this calibration is applied to captured data, it is sometimes referred to as a ‘color correction.’ Although the term ‘color correction’ is being used, it is meant to encompass any type of image improvement technique, including corrections for color, sharpness, contrast, and other demosaicing and image enhancement techniques. Therefore, in the present disclosure, ‘color correction’ is not limited to just color improvements.

Traditionally, color correction is performed on each captured frame when creating an HDR image. As shown in FIG. 1, which presents a drawing of operations performed by an existing or traditional HDR image generation system 110, HDR image generation system 110 may first capture multiple images with varied exposure levels (operation 112). Each of these images may then have color correction performed (operation 114). Once the color correction is complete, the images may be combined to form the HDR image (operation 116). Thus, in one example, five different exposure level images may be combined to form one HDR image after each of the five images first had color correction performed on them.

When HDR video is captured at a desired 60 fps (frames per second), the camera may need to capture 300 fps (five exposure levels per final frame) to create this HDR video. A processor may need to apply a color correction for each frame at 300 fps. Consequently, the use of HDR often makes the color-correction process computationally intensive, which may increase power consumption and memory requirements.

### SUMMARY

In a first group of embodiments, an RGB-IR color-correction method is described. This color-correction method may be implemented using an electronic device, such as: a camera, an integrated circuit, a computer system, or a vehicle. During operation, the electronic device decomposes a matrix calibration (e.g., a 3×4 matrix) into smaller calibrations, where the smaller calibrations include: IR crosstalk removal calibration, white-balance calibration, and 3×3 color-correction matrix calibration.

Moreover, the electronic device may re-compose calibration results into other forms, e.g., to meet the needs of different Image-Signal-Processor (ISP) designs and use cases. For example, the 3-element matrix form (a, b, c) of the color-correction matrix calibration may remove IR crosstalk from R, G, and B pixels without fully correcting the R, G, and B signals to final values. Note that IR crosstalk removal may be considered a preconditioning operation before color correction. It may also correct an IR light sensitivity difference of R/G/B pixels compared to values of the IR pixels.

Furthermore, when the matrix calibration has a 3-by-4 or 4-by-4 matrix form, the matrix calibration may convert 4-channel camera detected signals (R, G, B, IR) into a corrected color vector (R, G, B) without the preconditioning operation before color correction.

Additionally, the calibration method may be used with or without external optical devices, such as an optical IR filter used to physically isolate IR and visible light bands (which is typically used in conventional calibration techniques). Consequently, the disclosed calibration method may be more straightforward to deploy on the customer or user side.

In some embodiments, the electronic device may compute IR crosstalk coefficients (a, b, c) before white-balance estimation, based at least in part on a ratio between an increase in signal values of R, G, B pixels and IR pixels when in the presence of IR illumination. Notably, two image captures may be performed, one with IR illumination on and another with IR illumination off. Note that the only change between the two image captures may be the IR illumination being on or off. Then, the electronic device may compute R, G, B, and IR channel signal increments between the two images. Next, the electronic device may derive the IR crosstalk coefficients by dividing the R, G, and B channel signal increments with an IR channel signal increment.

Moreover, the electronic device may estimate white-balance gains after applying the IR crosstalk removal. The white-balance gains may be estimated from G over R and G over B ratios, in which R, G, and B are values collected from image captures of white patches in images that first have had the IR crosstalk removed.

Furthermore, the electronic device may compute the IR crosstalk coefficients (a, b, c) at the same time as white-balance parameter estimation based at least in part on a ‘white remains white’ criterion. Notably, images of white patches may be captured under multiple illuminations of interest with various visible and IR reflections. Then, R, G, B, and IR values may be collected per white patch per illuminant, and the white-balance parameter or value and the IR crosstalk coefficients (a, b, c) may be adjusted or optimized to minimize R, G, and B differences once the white balancing and the IR crosstalk removal are applied.

Additionally, after removing the IR crosstalk and white balancing an image, the electronic device may estimate 3×3 color-correction matrices by minimizing a total color error of a group of known color patches captured under illuminants of interest.

In some embodiments, the electronic device may determine other approaches for converting among different forms of coefficients (1×3+1×3+3×3, e.g., a stacked matrix, 3×4, 4×4, etc.) depending on different ISP designs and/or application scenarios.

Another embodiment provides the electronic device.

Another embodiment provides the integrated circuit.

Another embodiment provides a system that includes the electronic device or the integrated circuit.

Another embodiment provides a computer-readable storage medium with program instructions for use with the electronic device. When executed by the electronic device, the program instructions cause the electronic device to perform at least some of the aforementioned operations in one or more of the preceding embodiments.

Another embodiment provides the method, which may include at least some of the aforementioned operations in one or more of the preceding embodiments.

In a second group of embodiments, a method for calibrating an RGB-IR image sensor (including multiple pixels) is described. This calibration method may be implemented using an electronic device, such as: a camera, an integrated circuit, a computer system, or a vehicle.

During operation, each pixel in the RGB-IR image sensor produces a red color signal, a green color signal, a blue color signal, and an infrared signal, and the electronic device removes an infrared component (when present) from each of the red color signal, green color signal, and blue color signal. Moreover, the electronic device captures a first image under a first condition, including the presence of a first light to obtain a first red signal, a first green signal, a first blue signal, and a first infrared signal. Then, the electronic device captures a second image under a second condition by turning off the first light used when capturing the first image to obtain a second red signal, a second green signal, a second blue signal, and a second infrared signal.

Moreover, the electronic device may compute crosstalk coefficients using the first red signal, the second red signal, the first green signal, the second green signal, the first blue signal, the second blue signal, the first infrared signal, and the second infrared signal.

Furthermore, the electronic device may use the RGB-IR image sensor to capture multiple images of a color chart, including multiple patches, each of the multiple images of the color chart having different lighting conditions from another of the multiple images of the color chart.

For each of the multiple images of the color chart, the electronic device may determine crosstalk-corrected signals:

$$\begin{matrix}{R}_{i r s u b t r a c t} = R - a ▪ {IR}_{interp} ; \\ {G}_{i r s u b t r a c t} = G - b {▪ IR}_{interp} ; and \\ {B}_{i r s u b t r a c t} = B - c {▪ IR}_{interp} ,\end{matrix}$$

where R is a measured red color chart signal, G is a measured green color chart signal, B is a measured blue color chart signal, a, b, and c are a red crosstalk coefficient, a green crosstalk coefficient, and a blue crosstalk coefficient respectively, and IRᵢₙₜₑᵣₚ is an interpolation of measured infrared color chart signals.

The electronic device may estimate a mean red value, a mean green value, and a mean blue value for each color patch of the color chart. Furthermore, for each gray patch of the color chart, the electronic device may estimate a white-balance gain for the red mean value, a white-balance gain for the mean green value, and a white-balance gain for the mean blue value.

Additionally, the electronic device may generate a 3×3 color matrix that minimizes a color difference when using the mean red value, the mean green value, and the mean blue value for a respective color patch.

In some embodiments, the electronic device may obtain at least one of a 4×4 and a 3×4 correction matrix according to:

$$[ \begin{matrix}{c}_{1 , 1} & {c}_{1 , 2} & {c}_{1 , 3} & 0 \\ {c}_{2 , 1} & {c}_{2 , 2} & {c}_{2 , 3} & 0 \\ {c}_{3 , 1} & {c}_{3 , 2} & {c}_{3 , 3} & 0 \\ 0 & 0 & 0 & 1\end{matrix} ] \cdot [ \begin{matrix}{g}_{R} & 0 & 0 & 0 \\ 0 & {g}_{G} & 0 & 0 \\ 0 & 0 & {g}_{B} & 0 \\ 0 & 0 & 0 & 1\end{matrix} ] \cdot [ \begin{matrix}1 & 0 & 0 & - a \\ 0 & 1 & 0 & - b \\ 0 & 0 & 1 & - c \\ 0 & 0 & 0 & 1\end{matrix} ] ,$$

in which c_{m,n} are the m^{th} row, n^{th} column coefficients in the 3×3 color matrix.

Note that the operation of computing crosstalk coefficients may also include obtaining an incremental red signal that includes a difference between the first red signal and the second red signal, an incremental green signal that includes a difference between the first green signal and the second green signal, and incremental blue signal that includes a difference between the first blue signal and the second blue signal, and an incremental infrared signal that includes a difference between the first infrared signal and the second infrared signal.

Moreover, determining a red crosstalk coefficient ‘a’ may include a ratio of the incremental red signal and the incremental infrared signal; determining a green crosstalk ‘b’ coefficient may include a ratio of the incremental green signal and the incremental infrared signal;

and determining a blue crosstalk coefficient ‘c’ may include a ratio of the incremental blue signal and the incremental infrared signal.

Furthermore, the electronic device may capture the first image and the second image by capturing images of Mᵢ visually neutral flat surfaces from a standard color chart under N lighting conditions, and each of the first image and the second image may include i zones of image sections, where Mᵢ is for 1≤i≤N. Note that computing crosstalk coefficients may involve obtaining a reconstructed red signal R_{n,i}, a reconstructed blue signal B_{n,i}, a reconstructed green signal G_{n,i}, and a reconstructed infrared signal IR_{n,i} from at least the first red signal, the second red signal, the first green signal, the second green signal, the first blue signal, the second blue signal, the first infrared signal, and the second infrared signal. This reconstruction may use interpolation according to:

$$[ \begin{matrix}{R}_{n , 1} & 0 & {I}_{n , 1} & 0 \\ 0 & {B}_{n , 1} & 0 & {I}_{n , 1} \\ & … & & \\ {R}_{n , {M}_{n}} & 0 & {I}_{n , {M}_{n}} & 0 \\ 0 & {B}_{n , {M}_{n}} & 0 & {I}_{n , {M}_{n}}\end{matrix} ] \cdot [ \begin{matrix}{g}_{R , n} \\ {g}_{B , n} \\ {x}_{n} \\ {y}_{n}\end{matrix} ] = [ \begin{matrix}{G}_{1} \\ {G}_{1} \\ ⋯ \\ {G}_{n , {M}_{n}} \\ {G}_{n , {M}_{n}}\end{matrix} ]$$

and obtaining crosstalk coefficients a, b, c by obtaining the least mean squares according to

$$[ \begin{matrix}- {g}_{R , 1} & 1 & 0 \\ 0 & 1 & - {g}_{B , 1} \\ … & … & … \\ - {g}_{R , N} & 1 & 0 \\ 0 & 1 & - {g}_{B , N}\end{matrix} ] \cdot [ \begin{matrix}a \\ b \\ c\end{matrix} ] = [ \begin{matrix}{x}_{1} \\ {y}_{1} \\ … \\ {x}_{N} \\ {y}_{N}\end{matrix} ] .$$

The electronic device may display an image corrected by the correction matrix. In some embodiments, the first light may be an infrared light. Additionally, each of the red, green, blue, and infrared signals may be reconstructed from multiple pixel values.

Another embodiment provides a system for calibrating an RGB-IR image sensor that includes multiple pixels. The system may include: the RGB-IR sensor, a processor, and memory storing instructions for operations that are performed when the processor executes the instructions. The RGB-IR image sensor may include multiple pixels, each producing a red, green, blue, and infrared signal. The system may remove an infrared component from each of the red, green, and blue signals.

During operation, the system captures a first image under a first condition, including the presence of a first light to obtain a first red signal, a first green signal, a first blue signal, and a first infrared signal from the RGB-IR image sensor. Each pixel produces a red color signal, a green color signal, a blue color signal, and an infrared signal. Then, the system removes an infrared component from each of the red color signal, green color signal, and blue color signal.

Moreover, the system may capture a second image under a second condition by turning off the first light used when capturing the first image to obtain a second red signal, a second green signal, a second blue signal, and a second infrared signal.

Furthermore, using a crosstalk coefficient calculation unit, the system may compute crosstalk coefficients using the first red signal, the second red signal, the first green signal, the second green signal, the first blue signal, the second blue signal, the first infrared signal, and the second infrared signal.

Additionally, the system may use the RGB-IR sensor to capture multiple images of a color chart, including multiple patches, each of the multiple color chart images having different lighting conditions from another of the multiple color chart images. In some examples, multiple images on the color chart may be the first and second images (e.g., only two images may be captured, both of the color chart).

For each of the multiple color chart images, the system may determine crosstalk corrected signals:

$${R}_{irsubtract} = R - a \cdot {IR}_{interp} ;$$

$${G}_{irsubtract} = G - b \cdot {IR}_{interp} ; and$$

$${B}_{irsubtract} = B - c \cdot {IR}_{interp} ,$$

where R is a measured red color chart signal, G is a measured green color chart signal, B is a measured blue color chart signal, a, b, and c are a red crosstalk coefficient, a green crosstalk coefficient, and a blue crosstalk coefficient respectively, and IRᵢₙₜₑᵣₚ is an interpolation of measured infrared color chart signals.

Additionally, using a color estimation unit, the system may estimate a mean red value, a mean green value, and a mean blue value for each color patch of the color chart.

In some embodiments, using a white-balance gain unit, the system may estimate a white-balance gain for the red mean value, a white-balance gain for the mean green value, and a white-balance gain for the mean blue value for each gray patch of the color chart.

The system may generate a 3×3 color matrix that minimizes a color difference when using the mean red value, the mean green value, and the mean blue value for a respective color patch.

Note that, using a matrix generation unit, the system may obtain at least one of a 4×4 and a 3×4 correction matrix according to:

$$[ \begin{matrix}{c}_{1 , 1} & {c}_{1 , 2} & {c}_{1 , 3} & 0 \\ {c}_{2 , 1} & {c}_{2 , 2} & {c}_{2 , 3} & 0 \\ {c}_{3 , 1} & {c}_{3 , 2} & {c}_{3 , 3} & 0 \\ 0 & 0 & 0 & 1\end{matrix} ] \cdot [ \begin{matrix}{g}_{R} & 0 & 0 & 0 \\ 0 & {g}_{G} & 0 & 0 \\ 0 & 0 & {g}_{B} & 0 \\ 0 & 0 & 0 & 1\end{matrix} ] \cdot [ \begin{matrix}1 & 0 & 0 & - a \\ 0 & 1 & 0 & - b \\ 0 & 0 & 1 & - c \\ 0 & 0 & 0 & 1\end{matrix} ] ,$$

in which C_{m,n} are the m^{th} row, n^{th} column coefficients in the 3×3 color matrix.

Moreover, using the crosstalk coefficient calculation unit, the system may obtain an incremental red signal that includes a difference between the first red signal and the second red signal, an incremental green signal that includes a difference between the first green signal and the second green signal, and incremental blue signal that includes a difference between the first blue signal and the second blue signal, and an incremental infrared signal that includes a difference between the first infrared signal and the second infrared signal.

Furthermore, the system may: determine a red crosstalk coefficient ‘a’ that includes a ratio of the incremental red signal and the incremental infrared signal; determine a green crosstalk ‘b’ coefficient that includes a ratio of the incremental green signal and the incremental infrared signal; and determine a blue crosstalk coefficient ‘c’ that includes a ratio of the incremental blue signal and the incremental infrared signal.

Additionally, the capturing of the first image and the second image may involve capturing images of Mᵢ visually neutral flat surfaces from a standard color chart under N lighting conditions, and each of the first image and the second image may include i zones of image sections, where Mᵢ is 1≤i≤N. Note that computing crosstalk coefficients may involve obtaining a reconstructed red signal R_{n,i}, a reconstructed blue signal B_{n,i}, a reconstructed green signal G_{n,i}, and a reconstructed infrared signal IR_{n,i} from at least the first red signal, the second red signal, the first green signal, the second green signal, the first blue signal, the second blue signal, the first infrared signal, and the second infrared signal. This may involve the use of interpolation according to:

$$[ \begin{matrix}{R}_{n , 1} & 0 & {I}_{n , 1} & 0 \\ 0 & {B}_{n , 1} & 0 & {I}_{n , 1} \\ & & … & \\ {R}_{n , {M}_{n}} & 0 & {I}_{n , {M}_{n}} & 0 \\ 0 & {B}_{n , {M}_{n}} & 0 & {I}_{n , {M}_{n}}\end{matrix} ] \cdot [ \begin{matrix}{g}_{R , n} \\ {g}_{B , n} \\ {x}_{n} \\ {y}_{n}\end{matrix} ] = [ \begin{matrix}{G}_{1} \\ {G}_{1} \\ … \\ {G}_{n , {M}_{n}} \\ {G}_{n , {M}_{n}}\end{matrix} ]$$

and obtaining crosstalk coefficients a, b, c by obtaining the least mean squares according to

$$[ \begin{matrix}- {g}_{R , 1} & 1 & 0 \\ 0 & 1 & - {g}_{B , 1} \\ … & … & … \\ - {g}_{R , N} & 1 & 0 \\ 0 & 1 & - {g}_{B , N}\end{matrix} ] \cdot [ \begin{matrix}a \\ b \\ c\end{matrix} ] = [ \begin{matrix}{x}_{1} \\ {y}_{1} \\ … \\ {x}_{N} \\ {y}_{N}\end{matrix} ] .$$

In some embodiments, using a display, the system may display an image corrected by the correction matrix.

Note that the first light may be an infrared light. Additionally, each of the red, green, blue, and infrared signals may be reconstructed from multiple pixel values.

Moreover, the system may include an infrared filter, where one image of the first and the second images is captured with the infrared filter to block infrared light from the RGB-IR image sensor. The other image of the first and the second images may be captured with the infrared filter, which does not block infrared light from the RGB-IR image sensor.

Another embodiment provides the electronic device.

Another embodiment provides the integrated circuit.

Another embodiment provides a computer-readable storage medium with program instructions for use with the electronic device. When executed by the electronic device, the program instructions cause the electronic device to perform at least some of the aforementioned operations in one or more of the preceding embodiments.

Another embodiment provides the method, which may include at least some of the aforementioned operations in one or more of the preceding embodiments. For example, the method may include capturing a first image and a second image with an RGB-IR image sensor. Moreover, the method may include, based at least in part on the first image and the second image, determining infrared crosstalk data between sensor values from the RGB-IR image sensor. Furthermore, the method may include determining an infrared crosstalk removal calibration based at least in part on the determined infrared crosstalk data. Additionally, the method may include applying the infrared crosstalk removal calibration to data captured by the RGB-IR image sensor.

Note that the method may include computing a white-balance removal parameters based at least in part on the data created from the infrared crosstalk removal calibration and applying the white-balance removal parameters to the infrared crosstalk data created from the infrared crosstalk removal calibration.

Moreover, the method may include operating a camera on a vehicle, where the determined infrared crosstalk removal calibration is applied to each image captured by the vehicle camera.

In a third group of embodiments, computationally efficient generation of an HDR image by an electronic device is described. For example, the electronic device may include: a camera, an integrated circuit, a computer system, or a vehicle.

The electronic device may include an RGB-IR sensor with an array of pixels that capture light. Each pixel may be designed to capture Red, Green, Blue, or Infrared light. When light strikes the RGB-IR sensor, the sensor outputs data corresponding to the intensity of light received by each pixel. Moreover, the electronic device may include an analog-to-digital converter (ADC) that digitizes the data. Furthermore, while the sensor is operating, the electronic device varies exposure time for a given image capture to capture multiple images or a set of images (e.g., sequentially), each having a different exposure time. Then, using the ADC, the electronic device digitizes the multiple exposures for processing. Thus, the output of the ADC may be multiple streams of low-dynamic exposure images, each being RGB-IR patterned.

After capturing multiple images, the electronic device combines (e.g., using an HDR module) the images to form an HDR image. Notably, a multi-exposure combiner module in the electronic device dynamically computed combining weights according to local content of the images at different exposures. For example, the multi-exposure combiner module may combine multi-frame images through weighted averaging, resulting in a single-frame high-dynamic image. Thus, an unprocessed HDR image may be created without any individual (i.e., non-HDR) images being processed for color correction or other possible defects in the image as the sensor captured it.

Thus, the electronic device may perform processing on an HDR image after the unprocessed images are combined into an HDR image. The computational requirements may be significantly reduced because each image is not processed before the HDR image is formed. Additionally, in some embodiments, some of the aforementioned processing operations may be omitted, performed in parallel, or performed in a different order. Alternatively, there may be an additional operation.

Note that the HDR image may be a single image or may be a single frame from an HDR video.

Moreover, the electronic device may perform image correction on the HDR image (e.g., using an image correction module).

Furthermore, the electronic device may output the corrected HDR image (e.g., using an output module).

Additionally, the electronic device may capture multiple sets of images. Each of the sets of images may include a video stream having a different exposure. In these embodiments, the output module may output multiple HDR images as an HDR video.

In some embodiments, the electronic device may include an image analysis module that determines image errors based at least in part on the set of images or the HDR image, where the image correction module performs the error correction based at least in part on the image errors.

Note that the electronic device may include: a display that displays the corrected HDR image; and/or a driver assistance system that receives the corrected HDR image.

Another embodiment provides the integrated circuit.

Another embodiment provides a system that includes the electronic device or the integrated circuit. This system may include a non-transitory computer-readable medium storing instructions executable by a processor. The instructions may include instructions for capturing a set of images with a camera, where each image of the set has a different exposure. The instructions may include instructions for combining the set of images to form an HDR image. Moreover, the instructions may include performing image correction on the HDR image to create a corrected HDR image. Furthermore, the instructions may include outputting the corrected HDR image.

In some examples, the instructions for capturing a set of images further comprise instructions for capturing multiple sets of images.

Note that the multiple sets of images may each be a video stream having a different exposure.

Moreover, the instructions for outputting may provide HDR images as an HDR video.

Furthermore, the instructions may include instructions for analyzing the set of images or the HDR images to determine image errors, where the instructions for image correction are based at least in part on the image errors.

Additionally, the instructions for outputting the corrected HDR image may include at least one of: instructions for displaying the corrected HDR image; or instructions for providing the corrected HDR image to a driver-assistance system of a vehicle.

Another embodiment provides a computer-readable storage medium with program instructions for use with the electronic device. When executed by the electronic device, the program instructions cause the electronic device to perform at least some of the aforementioned operations in one or more of the preceding embodiments. For example, the operations may include: capturing a set of images with a camera or an image sensor, where each image of the set has a different exposure; combining the set of images to form an HDR image; performing image correction on the HDR image to create a corrected HDR image; and/or outputting the corrected HDR image.

Note that the set of images may include multiple sets of images. Each of the sets of images may include a video stream having a different exposure.

Moreover, the output corrected HDR image may include multiple HDR images in an HDR video.

Furthermore, the operations may include analyzing the set of images or the HDR image to determine image errors, performing image correction based at least in part on the image errors.

Additionally, outputting the corrected HDR image may include: displaying the corrected HDR image; and/or providing the corrected HDR image to a driver-assistance system in a vehicle.

Another embodiment provides a method for generating HDR images and/or video, which may be performed by the electronic device and may include at least some of the aforementioned operations in one or more of the preceding embodiments. For example, the electronic device may capture a set of images with a camera, where each image has a different exposure. Then, the electronic device may combine the set of images to form an HDR image. Moreover, the electronic device may perform image correction on the HDR image to create a corrected HDR image. Next, the electronic device may output the corrected HDR image.

Note that the set of images may include multiple sets of images. Note that each of the multiple sets of images may include a video stream having a different exposure.

Furthermore, the output corrected HDR image may include multiple HDR images in an HDR video.

Additionally, the electronic device may analyze the set of images to determine one or more image errors, where the image correction is based at least in part on the one or more image errors.

In some embodiments, outputting the corrected HDR image may include: displaying the corrected HDR image; and/or providing the corrected HDR image to a driver-assistance system of a vehicle.

In a fourth group of embodiments, a method for generating HDR images by an electronic device is described. For example, the electronic device may include: a camera, an integrated circuit, a computer system, or a vehicle. During operation, the electronic device captures a set of images with an RGB-IR camera, where each image of the set has a different exposure. Then, the electronic device combines the set of images to form an HDR image. Moreover, the electronic device performs image correction on the HDR image to create a corrected HDR image. Next, the electronic device outputs the corrected HDR image.

Note that capturing a set of images may include capturing multiple sets of images. For example, the multiple sets of images may each be a video stream having a different exposure. Moreover, the electronic device may output multiple HDR images as an HDR video.

Furthermore, the electronic device may analyze the set of images and/or the HDR image to determine image errors, where the image correction is based at least in part on the image errors.

Additionally, outputting the corrected HDR image may include at least one of: displaying the corrected HDR image; or providing the corrected HDR image to a driver-assistance system of a vehicle.

Another embodiment provides a system. This system may include: an RGB-IR camera that captures a set of images, where each image of the set has a different exposure; an HDR module that combines the set of images to form an HDR image; an image correction module that performs image correction on the HDR image to create a corrected HDR image; and an output module that outputs the corrected HDR image.

Note that the RGB-IR camera may capture multiple sets of images. For example, the multiple sets of images may each be a video stream having a different exposure. Moreover, the output module may output multiple HDR images as an HDR video.

Moreover, the system may include an image analysis module that determines image errors based at least in part on the set of images and/or the HDR image, where the image correction module performs the error correction based at least in part on the image errors.

Furthermore, the system may include at least one of: a display that displays the corrected HDR image; or a driver assistance system that receives the corrected HDR image.

Another embodiment provides a second system. This system includes: a non-transitory computer readable medium storing instructions executable by a processor, where the instructions include instructions for: capturing a set of images with an RGB-IR camera, where each image of the set has a different exposure; combining the set of images to form an HDR image; performing image correction on the HDR image to create a corrected HDR image; and outputting the corrected HDR image.

Note that capturing a set of images may include instructions for capturing multiple sets of images. For example, the multiple sets of images may each be a video stream having a different exposure. Moreover, the instructions may include instructions for outputting multiple HDR images as an HDR video.

Furthermore, the instructions may include instructions for analyzing the set of images and/or the HDR image to determine image errors, where the instructions for image correction is based at least in part on the image errors.

Additionally, the instructions for outputting the corrected HDR image may include at least one of: instructions for displaying the corrected HDR image; or instructions for providing the corrected HDR image to a driver-assistance system of a vehicle.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

FIG. 1 is a drawing illustrating operations performed by an existing High Dynamic Range (HDR) image generation system.

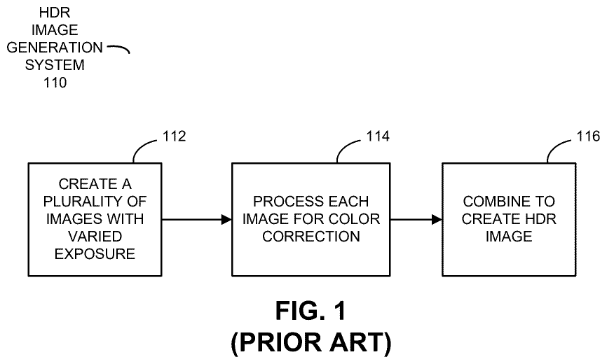

FIG. 2 is a diagram illustrating an example of components of an existing Red-Green-Blue (RGB) camera image processing system.

FIG. 3 is a diagram illustrating an example of a camera that includes a calibration system according to some embodiments of the present disclosure.

FIG. 4 is a diagram illustrating an example of components of a color calibration system according to some embodiments of the present disclosure.

FIG. 5 is a diagram illustrating an example of components of a color character parameter computation unit in a color calibration system according to some embodiments of the present disclosure.

FIG. 6 is a diagram illustrating an example of components of a crosstalk computation unit according to some embodiments of the present disclosure.

FIG. 7 is a diagram illustrating an example of components of a 3×3 color matrix computation after crosstalk removal according to some embodiments of the present disclosure.

FIG. 8 is a diagram illustrating an example of components in an image processing system in an RGB-IR camera according to some embodiments of the present disclosure.

FIG. 9 is a flow diagram illustrating an example of a method for performing a calibration according to some embodiments of the present disclosure.

FIG. 10 is a diagram illustrating an example of a camera including a calibration device according to some embodiments of the present disclosure.

FIG. 11 is a diagram illustrating an example of a camera including a calibration device according to some embodiments of the present disclosure.

FIG. 12 is a diagram illustrating an example of an HDR camera image processing system according to some embodiments of the present disclosure.

FIG. 13 is a flow diagram illustrating an example of a method for generating an HDR image according to some embodiments of the present disclosure.

Note that like reference numerals refer to corresponding parts throughout the drawings. Moreover, multiple instances of the same part are designated by a common prefix separated from an instance number by a dash.

### DETAILED DESCRIPTION

In a first group of embodiments, an RGB-IR color-correction method is described. This color-correction method may be implemented using an electronic device, such as: a camera, an integrated circuit, a computer system, or a vehicle. During operation, the electronic device decomposes a matrix calibration (e.g., a 3×4 matrix) into smaller calibrations, where the smaller calibrations include: IR crosstalk removal calibration, white-balance calibration, and 3×3 color-correction matrix calibration.

Moreover, in a second and third groups of embodiments, a method for calibrating an RGB-IR image sensor (including multiple pixels) is described. This calibration method may be implemented using an electronic device, such as: a camera, an integrated circuit, a computer system, or a vehicle.

Furthermore, in a fourth group of embodiments, a method for generating HDR images is described. This generating method may be implemented by an electronic device, such as: a camera, an integrated circuit, a computer system, or a vehicle.

While the discussion that follows is illustrated with the processing of a single image, in other embodiments, multiple images or video may be used.

We now describe the first, second, and third groups of embodiments of a calibration technique. Note that, in some examples, the present disclosure may include various other approaches for converting among different forms of coefficients (1×3+1×3+3×3, e.g., a stacked matrix, 3×4, 4×4, etc.), depending on different ISP designs and application scenarios.

In practice, the present disclosure may be performed in many different situations. In some embodiments, the method of the present disclosure may be performed in a lab setting with a camera sensor. In the lab setting, a baseline calibration matrix may be created. In some examples, this baseline calibration matrix may account for some crosstalk because of manufacturing for a given wafer. In another situation, the method of the present disclosure may be performed with an assembled camera module. The assembled camera module may include a camera sensor and other components, such as a lens, housing, etc. Different situations are also possible, such as when a camera module is mounted on a vehicle or included in an electronic device in the vehicle.

Furthermore, in some embodiments, one or more camera sensors from a given batch (e.g., from the same wafer of silicon) may have the method of the present disclosure performed to establish baseline parameters (e.g., a matrix) for the sensors from that wafer. These parameters may be applied as a baseline matrix for each sensor. Once the camera sensors are mounted in a housing and turned into a camera module, each individual module may have the method of the present disclosure performed to fine-tune the matrix for the given module. Thus, the matrix may be computed twice, with the first as a baseline for the bare camera sensor. In other examples, the procedure may be performed multiple times for different situations.

Reference will now be made in detail to embodiments, examples of which are illustrated in the accompanying drawings, where like reference numerals refer to like elements throughout. In this regard, the embodiments may have different forms and should not be construed as being limited to the descriptions set forth herein. Accordingly, the embodiments are merely described below by referring to the figures to explain aspects. As used herein, the term ‘and/or’ includes any and all combinations of one or more items listed in the associated list. Expressions such as “at least one of” when preceding a list of elements modify the entire list of elements and do not modify the individual elements of the list.

Also, in the present discussion, the term ‘units’ or ‘ . . . modules’ denotes units or modules that process at least one function or operation and may be realized by hardware, software, or a combination of hardware and software. The functions and processes described herein may be incorporated into one or more processor-based units to form an apparatus for performing the steps of color correction and calibration. In some examples, the process may be a general-purpose processor, an application-specific integrated circuit, a dedicated camera processor, or another form of computing processor. Additionally, when the term ‘image’ is used, it may be a single image from a camera or a video frame. Thus, this disclosure applies to both still images and videos.

Connections or connection members of lines between components shown in the drawings illustrate functional connections and/or physical or circuit connections. The connections illustrated do not preclude other functional units interposed between the functional units illustrated.

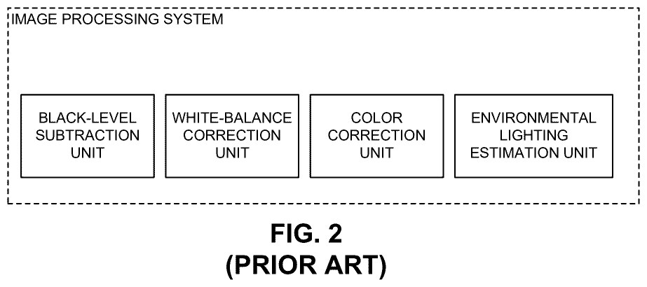

FIG. 2 presents a diagram illustrating an example of components of a conventional RGB camera image processing system. A conventional RGB camera image processing system may include: a black-level subtraction unit, a white-balance correction unit, a color correction unit, and an environmental lighting estimation unit. Although the blocks are described and shown in a specific order, they do not necessarily have to be performed in this order. The blocks of FIG. 2 may be performed after a camera system captures a test image. The test image may be captured using a test pattern with a predetermined color pattern, including black and white.

The black-level subtraction unit may adjust the black levels of a captured image. The black level may be the signal level representing a darkest part of an image. When the test pattern has a black region, the difference between the color identified by the sensor and ‘true black’ may be corrected at this block. In practice, ‘true black’ ideally corresponds to zero light or the absence of light, and the sensor should see no light from the black region. However, because of various factors like sensor noise, electronic noise, temperature variations, and reflections from the surface of the test image, the actual signal level for black is usually not zero. This non-zero baseline may need to be corrected to ensure accurate image reproduction.

The white-balance correction unit is similar to the black level subtraction unit in that it adjusts for inconsistencies in ‘pure white’ rather than ‘true black.’ When the test pattern has a white region, the difference between the color identified by the sensor and ‘pure white’ may be corrected at this block. When a camera sensor captures light from a white section of the test pattern, it may have some color distortions that are corrected by this block. This block can offset for the offset from the camera sensor for a pure white region.

The color correction unit may operate similarly to the black-level and white-balance units, but for each of the primary colors: red, blue, and green. An offset for each color may be determined and applied at this block to ensure the accuracy of color representation.

The environmental lighting estimation unit may offset the ambient lighting conditions by which an image of the test pattern was captured. A light white light may be used to capture the test image of the test pattern; white lighting sources have color temperatures that may induce some environmental lighting issues. For example, a warmer white light has more yellow light, whereas a cooler white light has more blue light components. The environmental lighting estimation unit can offset these ambient lighting conditions of the environment in which the test image is captured.

Note that there may be different ways to accomplish the goal of each of the blocks in FIG. 2.

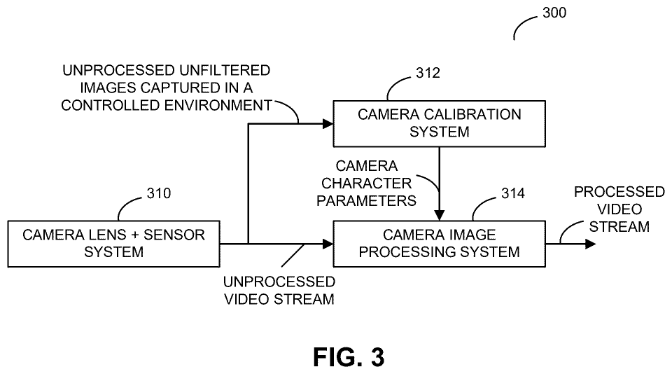

FIG. 3 presents a diagram illustrating an example of a calibration system 300 in which the RGB-IR calibration of the disclosure may be employed. The arrangement includes a camera sensor and lens system 310, a camera calibration system 312, and a camera imaging processing system 314. Camera calibration system 312 is typically activated at the time of set up. As described later, the camera calibration system 312 may be a system to test camera sensors in a lab setting, or the camera calibration system 312 may be a system to test assembled camera modules.

Additionally, in some examples, the camera lens may be omitted in lens system 310, and the system may operate only with a camera sensor. The camera calibration results may be input to camera imaging processing system 314 to provide compensation during normal operations based at least in part on the results obtained in a camera calibration phase.

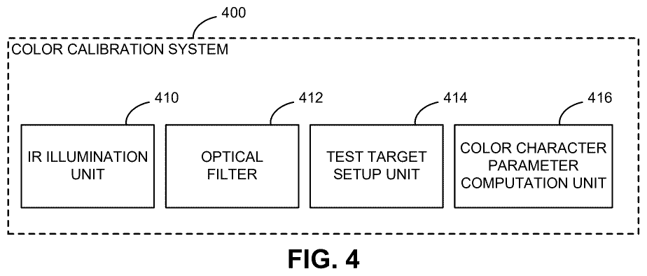

As mentioned previously, because of IR crosstalk, RGB-IR cameras benefit from color correction to improve image quality; in various embodiments, this matrix may be a 4×4, 3×4, or other matrix. According to some embodiments of constructing the 4×4 matrix, a pair of images is obtained. Referring to FIG. 4, which presents a diagram illustrating an example of components of a color calibration system 400, color calibration system 400 may include illumination unit 410, test target scene set up unit 414, and a color character parameter computation unit 416. In some examples, illumination unit 410 may be an IR illumination unit, a visible light illumination unit, or a combination of both IR and visible light illumination units. Optionally, one or more optical filters 412 (such as an external optical bandpass filter) may be provided for filtering (or removing) infrared light. However, in some embodiments, an infrared filter is not necessary for the one or more optical filters 412.

The test target scene set up unit 414 may include a test pattern with a pre-determined color pattern, including black and white. Note that color calibration system 400 may capture an image of the test pattern as part of the test target scene set up unit 414.

A first image of the pair may be captured with illumination unit 410 on, and a second image of the pair may be captured with the illumination unit 410 off. The camera settings (e.g., exposure time and gain) may be identical during the image capture with the illumination on and the image capture with the illumination off. Furthermore, the two image capture events may have the same (or substantially the same) scene composition with non-zero reflection. The reflection spectrum may be approximately even or broader than the operational spectrum range of the camera. The ambient lighting may be nonzero but ideally should be relatively stable across the two image captures. In some embodiments, when ambient light exists, the ambient light and the scene composition may remain relatively unchanged across the two captures.

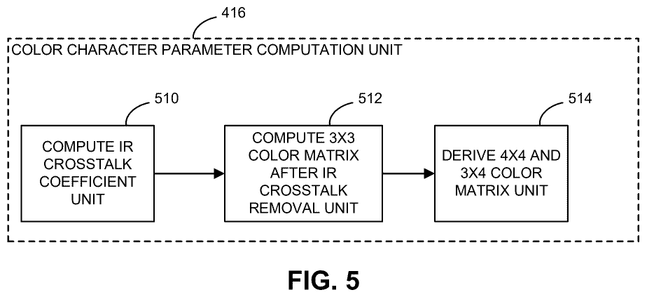

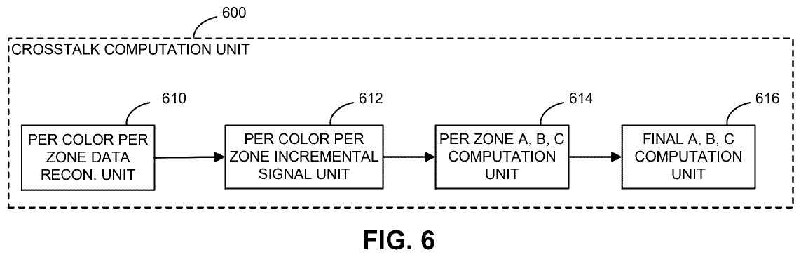

After the two image captures, the IR contribution for each color R, G, and B may be determined. Color character parameter computation unit 416 may determine the IR contribution and cause the removal thereof. In FIG. 5, which presents a diagram illustrating an example of components of color character parameter computation unit 416 in a color calibration system, color character parameter computation unit 416 may include a 3×3 color matrix computation after IR removal unit 512 and a 4×4 (or 3×4) color compensation matrix computation unit 514. Furthermore, IR crosstalk computation unit 600 is shown in FIG. 6, which presents a diagram illustrating an example of components of a crosstalk computation unit 600. This IR crosstalk computation unit may include a color zone data reconstruction unit 610, an incremental signal computation unit 612, a per-zone coefficient computation unit 614, and a final coefficient computation unit 616.

In the color zone data reconstruction unit 610, some embodiment may obtain a single value per color channel per local zone. The number of local zones may be set based at least in part on a size of the zone. The zone can be as small as 1 pixel, multiple pixels of a region of interest, or as big as a whole frame. Initial measurements may be denoted as R_{iron,i}, G_{iron,i}, B_{iron,i}, and IR_{iron,i}, when the IR source is on and R_{iroff,i}, G_{iroff,i}, B_{iroff,i}, and IR_{iroff,I}) when the IR source is off, in which ‘i’ is the index to the zones. In embodiments where there is no ambient light when the images are captured, per zone per channel values (R_{iroff,i}, G_{iroff,i}, B_{iroff,i}, and IR_{iroff,I}) may be replaced by another form of black-level values (e.g., per channel whole frame black level, single black level across all channels and all pixels in the frame, etc.).

A reconstruction technique known to one skilled in the art can be used to reconstruct the component channel signals. For example, interpolation may be used, where R, G, B, and IR are reconstructed at each pixel and further downsampled to yield a single value per color channel per zone.

In the per color per zone incremental signal computation unit 612, incremental signal values per color channel per local zone may be calculated according to:

$${R}_{inc , i} = {R}_{iron , i} - {R}_{iroff , i} ,$$

$${G}_{inc , i} = {G}_{iron , i} - {G}_{iroff , i} ,$$

$${B}_{inc , i} = {B}_{iron , i} - {B}_{iroff , i} , and$$

$$I {R}_{inc , i} = I {R}_{iron , i} - I {R}_{iroff , i} .$$

Using the incremental values, per zone coefficient computation unit 614 may determine the IR crosstalk coefficients a, b, and c per local zone may be calculated according to:

$${a}_{i} = {R}_{inc , i} / {IR}_{inc , i ,}$$

$${b}_{i} = {G}_{inc , i} / {IR}_{inc , i ,} and$$

$${c}_{i} = {B}_{inc , i} / {IR}_{inc , i .}$$

Note that the final coefficient computation unit 616 may aggregate aᵢ, bᵢ, and cᵢ per zone i to obtain the final a, b, and c values.

The above description is of an approach to determine the IR crosstalk coefficients. The determination of the crosstalk component may not include a mandatory operation of deploying an IR filtering step as part of the calibration. This may ease the hardware requirements at the user end. However, in some embodiments, an IR filter may be used to capture the second image.

An alternate approach to determine the IR crosstalk coefficients according to some embodiments is described below.

Capture images under N (where N≥2) environmental lighting conditions that are pertinent to the application where the RGB-IR camera is deployed. The captured images may contain Mᵢ (1≤I≤N) visually neutral flat surfaces, which can come from a standard color-checker target.

Following the N image captures, an R, G, and B IR signal reconstructing operation may obtain a single value per color channel per local zone (specified inside the neutral flat surfaces). The number of zones may vary; each zone may contain one or many pixels. For example, an image may be divided into multiple zones containing multiple pixels, or the image may be processed on a per-pixel basis. The results may be denoted as R_{n,i}, G_{n,i}, B_{n,i}, and IR_{n,i}, where ‘n’ is the index to the environmental lighting, and ‘i’ is the index for the zones. A reconstructing technique known to one skilled in the art may be used. Example reconstruction techniques may include interpolation, so that R, G, B, and IR are reconstructed at each pixel, and then further downsampled to yield a single value per color channel per zone. In these embodiments, the color parameters may be estimated based at least in part on an approximation of pure white.

As an example, solving by a least mean squares technique may lead to these values: g_{R,n}, g_{B,n}, xₙ, and yₙ, where ‘g_{R,n}’ is the white-balance gain for the red channel under the n^{th} illuminant, ‘g_{B,n}’ is the white-balance gain for blue channel under the n^{th} illuminant, ‘xₙ’ is an intermediate variable, xₙ=b−g_{R,n}* , and ‘yₙ’ is an intermediate variable, yₙ=b−g_{B,n}*c:

$$[ \begin{matrix}{R}_{n , 1} & 0 & {I}_{n , 1} & 0 \\ 0 & {B}_{n , 1} & 0 & {I}_{n , 1} \\ & & … & \\ {R}_{n , {M}_{n}} & 0 & {I}_{n , {M}_{n}} & 0 \\ 0 & {B}_{n , {M}_{n}} & 0 & {I}_{n , {M}_{n}}\end{matrix} ] \cdot [ \begin{matrix}{g}_{R , n} \\ {g}_{B , n} \\ {x}_{n} \\ {y}_{n}\end{matrix} ] = [ \begin{matrix}{G}_{1} \\ {G}_{1} \\ … \\ {G}_{n , {M}_{n}} \\ {G}_{n , {M}_{n}}\end{matrix} ] .$$

Then, solving below using the least mean square technique may result in final a, b, and c values, obtained via the final coefficient computation unit 616:

$$[ \begin{matrix}- {g}_{R , 1} & 1 & 0 \\ 0 & 1 & - {g}_{B , 1} \\ … & … & … \\ - {g}_{R , N} & 1 & 0 \\ 0 & 1 & - {g}_{B , N}\end{matrix} ] \cdot [ \begin{matrix}a \\ b \\ c\end{matrix} ] = [ \begin{matrix}{x}_{1} \\ {y}_{1} \\ … \\ {x}_{N} \\ {y}_{N}\end{matrix} ]$$

The operation of R, G, B, and IR signal reconstruction to obtain a single value per color channel per zone may be applied to each ‘relevant environmental lighting’ N. Similarly, the determination of the least mean square process may be applied for each relevant lighting N. The result of the reconstruction and the least mean square determination may be N sets of white-balance gains and 3×3 color matrix. The determination of the 3×3 color matrix is further discussed below.

Once the IR coefficients a, b, and c are determined (using one of the abovementioned approaches), a 3×3 color correction matrix may be computed for the RGB-IR camera.

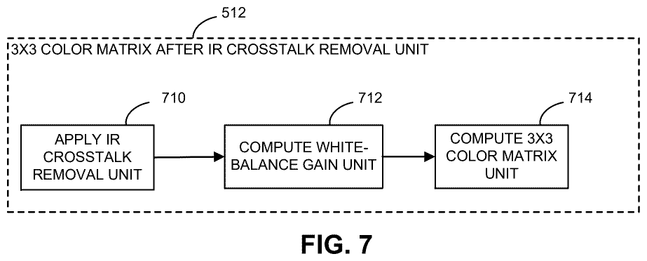

Referring to FIG. 7, which presents a diagram illustrating an example of components of a 3×3 color matrix computation after crosstalk removal 512, a 3×3 color matrix computation after IR removal unit 512 may receive the coefficients a, b, and c from the IR crosstalk computation unit 510. This may involve capturing images with, for example, a color-checker in the scene under various environment lighting conditions via the target scene set-up unit 414 that pertain to the application in which the RGB-IR camera is deployed. The number of environmental lighting may be denoted as N, where N is a non-zero integer.

In FIG. 7, crosstalk removal unit 710 may remove the IR crosstalk from the R, G, and B pixels in the captured setup images:

$${R}_{irsubtract} = R - a * {IR}_{interp} ,$$

$${G}_{irsubtract} = G - b * {IR}_{interp} , and$$

$${B}_{irsubtract} = B - c * {IR}_{interp}$$

Note: IRᵢₙₜₑᵣₚ may be the reconstructed IR signal at the location of the R, G, and B pixel where IR subtraction occurs. The reconstruction may be done via an interpolation or reconstruction technique.

In addition to the IR subtraction result, the process may run through the RGB camera's color correction matrix computation operations (as shown in FIG. 4). The color correction matrix computation may include estimating the mean R_{mean,i}, G_{mean,i}, B_{mean,i} values from each color patch of the color patches with known color.

White-balance gain computing unit 712 may estimate white-balance gains g_{R}, g_{G}, g_{B} from the grey patches in the capture and apply to R_{mean,i}, G_{mean,i}, B_{mean,i} to yield R_{wb,i}, G_{wb,i}, B_{wb,i}.

Moreover, using the least square technique or a numerical optimization technique, 3×3 color matrix unit 714 may generate a 3×3 color matrix, which may generate the minimum color difference when applied to the R, G, and B values of the color patches.

Referring again to FIG. 5, after computing the 3×3 color matrix after crosstalk removal in unit 512 the 4×4 or 3×4 color correction matrix unit 514 may generate the calibration matrix for the RGB-IR camera.

Note that the color compensation matrix computation unit 514 may determine the 4×4 color correction matrix using:

$$[ \begin{matrix}{c}_{1 , 1} & {c}_{1 , 2} & {c}_{1 , 3} & 0 \\ {c}_{2 , 1} & {c}_{2 , 2} & {c}_{2 , 3} & 0 \\ {c}_{3 , 1} & {c}_{3 , 2} & {c}_{3 , 3} & 0 \\ 0 & 0 & 0 & 1\end{matrix} ] \cdot [ \begin{matrix}{g}_{R} & 0 & 0 & 0 \\ 0 & {g}_{G} & 0 & 0 \\ 0 & 0 & {g}_{B} & 0 \\ 0 & 0 & 0 & 1\end{matrix} ] \cdot [ \begin{matrix}1 & 0 & 0 & - a \\ 0 & 1 & 0 & - b \\ 0 & 0 & 1 & - c \\ 0 & 0 & 0 & 1\end{matrix} ] ,$$

in which c_{m,n} are the m^{th} row, n^{th} column coefficients in the 3×3 color matrix computed by the 3×3 color matrix after crosstalk removal in unit 512.

Alternatively, the 4×4 color matrix may be simplified to 3×4 because only the first three rows (for R, G, B) matter.

Note N that sets the 4×4 or 3×4 matrix may be generated from the preceding operation.

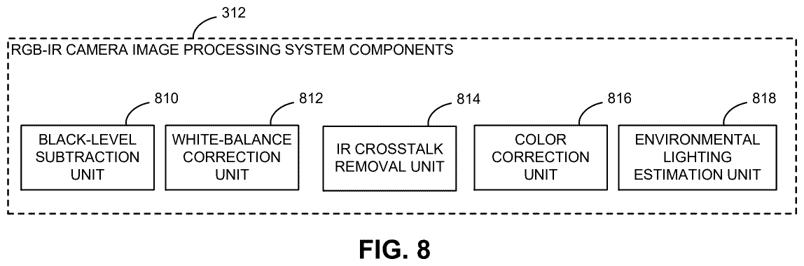

Referring back to FIG. 3, in some embodiments of the disclosed color correction method performed in the camera calibration system 312 may then be communicated into the image processing system 314 as part of the image processing pipeline in the camera. FIG. 8 presents a diagram illustrating an example of components of an image processing system 312 in an RGB-IR camera. Notably, image processing system 312 may include: a black subtraction unit 810, a white-balance correction unit 812, an IR crosstalk removal unit 814, a color correction 816, and an environmental lighting estimation unit 818.

As discussed previously, the disclosed calibration may be performed on a camera sensor and/or a camera module before the sensor or module is put into operation. Image processing system 314 in FIG. 8 may receive the calibration parameters from the camera calibration system 312. Image processing system 314 may be performed while the camera operates on a vehicle or anywhere a camera may be used. In practice, image processing system 314 may apply the matrix determined by camera calibration system 312 in FIG. 3 to perform the IR removal and color correction.

The processor pipeline can be summarized as including the operations of environmental lighting estimation and IR interpolation for some or all pixels where IR data is missing in the original camera sensor output (unprocessed data). This operation may be omitted if the operations of determining the 3×3 color correction matrix are performed. Optionally, R, G, and B interpolation may be performed for some or all pixels where corresponding color channel data is missing in the original camera sensor output (unprocessed data). IR crosstalk removal may be performed for some or all the available R, G, and B data. White balance may be performed for some or all of the output R, G, and B data available (e.g., N data sets). Moreover, color correction may be applied to the previous resulting R, G, and B with a 3×3 matrix.

Once the color correction is determined, the corrected color signals may be output for display. Example displays may take the form of surveillance and head-up displays. Other displays, such as an in-cabin display in a vehicle and security camera displays, are also possible. Functionally, this disclosure may operate with any display coupled to a camera or displaying video or images captured by a camera with an RGB-IR sensor. In other embodiments, rather than outputting the images for display, a driver-assistance system may use the corrected images. The driver-assistance system may operate the vehicle autonomously or assist in its operation. By improving image quality, the driver-assistance system may be able to control the vehicle more accurately.

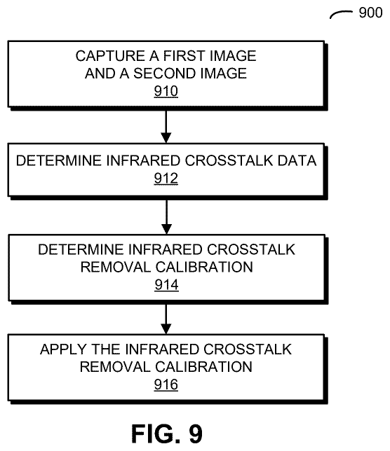

We now describe embodiments of a method. FIG. 9 presents a flow diagram illustrating an example of a method 900 for performing a calibration using an electronic device. During operation, the electronic device may capture a first image and a second image (operation 910) with an RGB-IR image sensor. Then, the electronic device may determine, based at least in part on the first image and the second image, infrared crosstalk data (operation 912) between sensor values from the RGB-IR image sensor. Moreover, the electronic device may determine an infrared crosstalk removal calibration (operation 914) based at least in part on the determined infrared crosstalk data. Next, the electronic device may apply the infrared crosstalk removal calibration (operation 916) to data captured by the RGB-IR image sensor.

In some embodiments of the method 900, there may be additional or fewer operations. Moreover, the order of the operations may be changed, and/or two or more operations may be combined into a single operation.

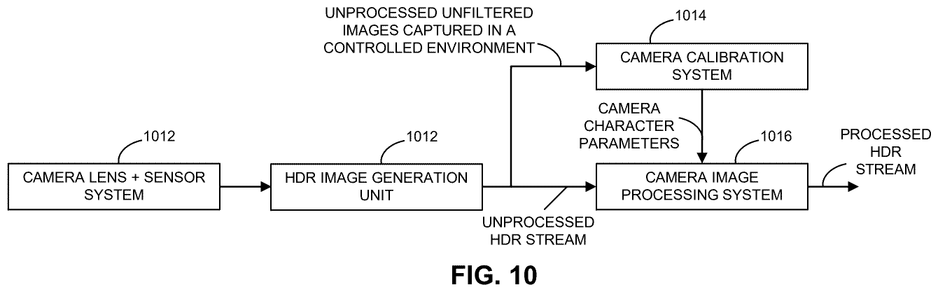

We now describe the fourth group of embodiments for generating an HDR image. FIG. 10 presents a diagram illustrating an example of a camera including a calibration device. This camera may include: a camera lens and sensor system 1010, an HDR image generation unit 1012, a camera calibration system 1014, and a camera imaging processing system 1016.

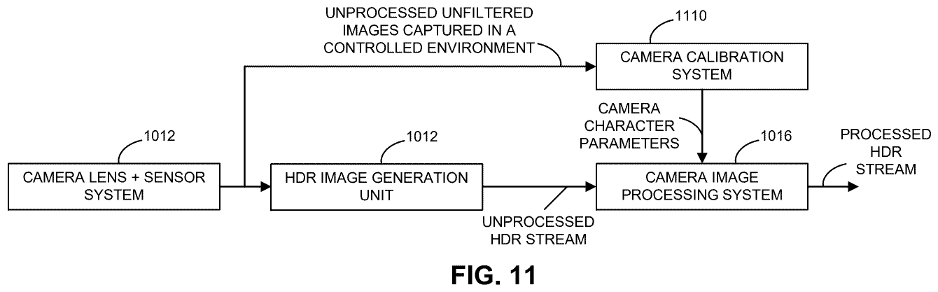

Moreover, FIG. 11 presents a diagram illustrating an example of a camera including a calibration device according to some embodiments of the present disclosure. This camera may include a camera calibration system 1110.

FIGS. 10 and 11 may generally operate similarly, except that in FIG. 10, the camera calibration system 1014 may operates on images output from HDR image generation unit 1014, and in FIG. 11, camera calibration system 110 may operate on images output from camera lens and sensor 1010. Thus, the difference may include how the calibration is performed.

Camera lens and sensor 1010 may rapidly capture a set of several images, each having a different exposure level. Some images may be underexposed, capturing less light to make bright areas appear darker. Some images may be captured with a standard exposure, so some areas are bright, and others are dark. And, some images may be overexposed, capturing a higher amount of light to make dark areas appear brighter. In different embodiments, various numbers of images may be captured by the camera lens and sensor 1010 to create the set of images. In some embodiments, the camera lens and sensor 1010 output may include multiple parallel streams of images (e.g., video streams), where each stream may have a different exposure level.

The HDR image generation unit 1012 may combine the set of images into a single HDR image. The HDR image generation unit 1012 (which is sometimes referred to as a ‘multi-exposure combiner module’) may dynamically compute the combining weights (for images in the set of images) according to the local content of the multi-exposure images. Note that combining the multi-frame images through weighted averaging may result in a single-frame high-dynamic image. Various techniques may be used by the HDR image generation unit 1012 to create the output from the HDR image generation unit 1012. One skilled in the art may use any applicable means to generate HDR images from the raw multi-exposure images or video streams. The output may be a series of HDR images and/or HDR video streams.

The camera calibration system 1014 may be activated at the time of set up. The camera calibration system 1014 may determine errors, color issues, color temperature issues, gamma issues, infrared crosstalk issues, defective pixel issues, noise issues, and/or other image quality issues. As shown in FIG. 10, the camera calibration system 1014 may take HDR images from the HDR image generation unit 1012 to determine image issues. In other embodiments, as shown in FIG. 11, the camera calibration system 1110 may take HDR images from the camera lens and sensor 1010 to determine image issues.

In practice, camera calibration systems 1014 and/or 1110 may be used in many different situations. In one situation, camera calibration systems 1014 and/or 1110 may be used in a lab setting with a camera sensor. In the lab setting, a baseline calibration matrix may be created. In some embodiments, this baseline calibration matrix may be able to account for some crosstalk that is due to manufacturing for a given wafer. In another situation, the camera calibration systems 1014 and/or 1110 may be performed with an assembled camera module. The assembled camera module may include the camera sensor and other components, such as a lens, housing, etc. Other situations are also possible, such as when a camera module is mounted on a vehicle.

Furthermore, in some cases, one or more camera sensors from a given batch (e.g., from the same wafer of silicon) may have the method of the present disclosure performed to establish baseline parameters (e.g., matrix) for the sensors from that wafer. These parameters may be applied as a baseline matrix for each sensor. Once the camera sensors are mounted in a housing and turned into a camera module, each individual module may have the method of the present disclosure performed to fine-tune the matrix for the given module. Thus, the matrix may be computed twice, with the first as a baseline for the bare camera sensor. In other embodiments, the procedure may be performed multiple times for other different situations.

In either situation (FIG. 10 or 11), the camera calibration results may be input to the camera image processing system 1016 to provide compensation during normal operations based at least in part on the results obtained in a camera calibration phase. Thus, the HDR images (or video) output by HDR image generation unit 1012 may be processed and corrected based at least in part on the calibration.

As discussed previously, in a traditional HDR image system, the raw images may be corrected before being combined into an HDR image. In a setting where HDR video is being captured at a desired 60 fps, the camera may need to capture 300 fps (at an example of five exposure levels per final frame) to create this HDR video. The processor may have to apply color correction for each of the 300 fps. Therefore, the color correction process may become computationally intensive.

Conversely, in the present disclosure, the camera may capture the same 300 fps, but those images may be combined to form a 60 fps HDR video stream. Once the HDR video stream is created, the processor may only have to apply a color correction for the 60 fps HDR video feed. Thus, the color correction process may be significantly less computationally intensive. Theoretically, the reduced computational power needed may be based at least in part on the number of frames combined to make the HDR image. That is, if five images are combined to make an HDR image, the present disclosure may use approximately one-fifth of the traditional computation power of a traditional HDR system to apply color correction.

In various embodiments, many different image processing techniques may be used by the camera calibration systems 1014 and/or 1110. Almost any image processing technique used to improve image or video quality may be part of the camera calibration systems 1014 and/or 1110. Additionally, camera calibration systems 1014 and/or 1110 may perform the calibration techniques discussed previously.

In some embodiments, the unprocessed HDR image is processed by a single defective pixel correction module instance to remove defective pixels. The defective pixel module may determine when a single pixel (such as an R, G, B, or IR pixel) or a group of pixels is malfunctioning. When a malfunction is determined to exist, this module may calculate an approximation of what the value of the pixel should have been when it was functioning correctly. This corrected pixel data may replace the defective pixel data in the unprocessed HDR image data.

In some additional embodiments, the resulting HDR image may be processed by a single noise reduction module instance to remove noise. Noise may manifest as graininess, speckles, or other artifacts in a captured image. This module may adjust the data of the captured HDR image to reduce the noise present in the HDR image.

Additionally, embodiments may include the resulting HDR stream being analyzed to determine information and statistics related to visible light and infrared light. Color correction and IR crosstalk removal operations may use this color and infrared information. An IR interpolation module may process the HDR image to generate a fully sampled IR image from the captured RGB-IR image. This fully sampled IR image may be an infrared-only representation of the captured image. An IR removal module instance may use this IR image to remove the IR crosstalk signal in RGB pixels. Thus, the resulting image may have IR crosstalk errors removed from the HDR image.

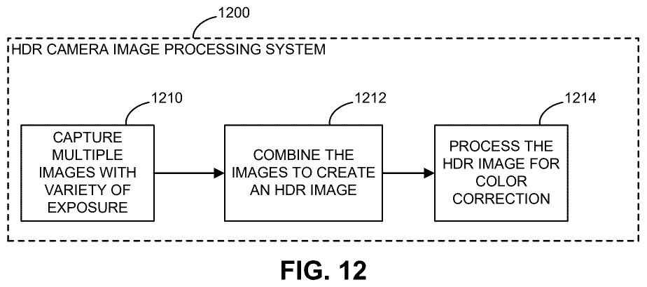

After infrared crosstalk is removed from the image, the resulting HDR image may be processed by a white balance module instance to make the white object appear white in the output image stream. A tone mapping module instance may process the resulting white-balanced HDR image to compress the image bit-depth to a lower number. A single RGB interpolation module instance may process the resulting tone-mapped image to recover R, G, and B information at every pixel location. The resulting R, G, and B information may be processed by a single RGB color correction module instance and a single Gamma correction module instance to obtain the color that is accurate to the human eye when displayed. This is illustrated in FIG. 12, which presents a diagram illustrating an example of an HDR camera image processing system 1200, which may perform the operations of: capturing multiple images with varied exposure (operation 1210); combine the images to create an HDR image (operation 1212); and processes the HDR image for color correction (operation 1214).

The corrected color signals may be displayed once the color correction is applied to the HDR images or video stream. For example, displays may take the form of surveillance and head-up displays. Other displays, such as an in-cabin display in a vehicle and security camera displays, are also possible. Functionally, this disclosure may operate with any display coupled to a camera or displaying video or images captured by a camera with an RGB-IR sensor. In other embodiments, rather than outputting the images for display, a driver-assistance system may use the corrected images. The driver-assistance system may operate the vehicle autonomously or assist in its operation. By improving image quality, the driver-assistance system may be able to control the vehicle more accurately. In some other embodiments, the outputting may store an HDR image or HDR video in memory.

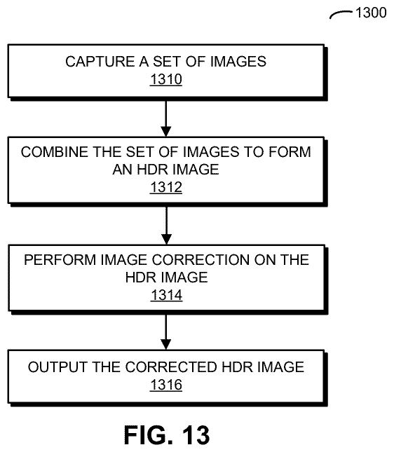

We now describe embodiments of a method. FIG. 13 presents a flow diagram illustrating an example of a method 1300 for generating an HDR image using an electronic device. During operation, the electronic device may capture a set of images (operation 1310 with an RGB-IR camera, where each image of the set has a different exposure. Then, the electronic device may combine the set of images to form an HDR image (operation 1312). Moreover, the electronic device may perform image correction on the HDR image (operation 1314) to create a corrected HDR image. Next, the electronic device may output the corrected HDR image (operation 1316).

In some embodiments of the method 1300, there may be additional or fewer operations. Moreover, the order of the operations may be changed, and/or two or more operations may be combined into a single operation.

The disclosed electronic device and the calibration and HDR techniques can be (or can be included in) any electronic device or system. For example, the electronic device may include: a cellular telephone or a smartphone, a tablet computer, a laptop computer, a notebook computer, a personal or desktop computer, a netbook computer, a media player device, an electronic book device, a MiFi® device, a smartwatch, a wearable computing device, a portable computing device, a consumer-electronic device, an access point, a router, a switch, communication equipment, test equipment, a vehicle, a ship, an airplane, a car, a truck, a bus, a motorcycle, manufacturing equipment, farm equipment, construction equipment, or another type of electronic device.

Although specific components are used to describe the embodiments of the electronic device, in alternative embodiments different components and/or subsystems may be present in the electronic device. Thus, the embodiments of the electronic device may include fewer components, additional components, different components, two or more components may be combined into a single component, a single component may be separated into two or more components, one or more positions of one or more components may be changed, and/or there may be different types of components.

Moreover, the circuits and components in the embodiments of the electronic device may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar. Note that electrical coupling or connections in the preceding embodiments may be direct or indirect. In the preceding embodiments, a single line corresponding to a route may indicate one or more single lines or routes.

As noted previously, an electronic device may implement some or all of the functionality of the calibration and/or HDR techniques. This electronic device may include hardware and/or software mechanisms that are used for implementing functionality associated with the calibration and/or HDR techniques.

In some embodiments, an output of a process for designing an integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII), Electronic Design Interchange Format (EDIF), OpenAccess (OA), or Open Artwork System Interchange Standard (OASIS). Those of skill in the art of integrated circuit design can develop such data structures from schematic diagrams of the type detailed above and the corresponding descriptions and encode the data structures on the computer-readable medium. Those of skill in the art of integrated circuit fabrication can use such encoded data to fabricate integrated circuits that include one or more of the circuits described herein.

While some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software, or both. For example, at least some of the operations in the calibration and/or HDR techniques may be implemented using program instructions that are executed by a processor or in firmware in the electronic device.

Moreover, while examples of numerical values are provided in the preceding discussion, in other embodiments different numerical values are used. Consequently, the numerical values provided are not intended to be limiting.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. A method, comprising:
by an electronic device:
capturing a first image and a second image with a Red-Green-Blue-infrared (RGB-IR) sensor image sensor;
based at least in part on the first image and the second image, determining infrared crosstalk data between sensor values from the RGB-IR image sensor;
determining an infrared crosstalk removal calibration based at least in part on the determined infrared crosstalk data; and
applying the infrared crosstalk removal calibration to data captured by the RGB-IR image sensor.

2. The method of claim 1, wherein the method comprises:
computing white-balance removal parameters based at least in part on the data created from the infrared crosstalk removal calibration; and
applying the white-balance removal parameters to the data created from the infrared crosstalk removal calibration.

3. The method of claim 1, wherein the method comprises operating a camera on a vehicle, and wherein the determined infrared crosstalk removal calibration is applied to each image captured by the camera of the vehicle.

4. The method of claim 1, wherein the RGB-IR sensor comprises multiple pixels, and each pixel produces a red color signal, a green color signal, a blue color signal, and an infrared signal, and the method removes an infrared component from each of the red color signal, green color signal and blue color signal.

5. The method of claim 1, wherein the first image is captured under a first condition, comprising a presence of a first light to obtain a first red signal, a first green signal, a first blue signal, and a first infrared signal; and
wherein the second image is captured under a second condition by turning off the first light used when capturing the first image to obtain a second red signal, a second green signal, a second blue signal, and a second infrared signal.

6. The method of claim 5, wherein the infrared crosstalk data is determined based at least in part on the first red signal, the second red signal, the first green signal, the second green signal, the first blue signal, the second blue signal, the first infrared signal, and the second infrared signal.

7. The method of claim 1, wherein the method comprises using the RGB-IR image sensor to capture multiple images of a color chart comprising multiple patches, each of the multiple color chart images having different lighting conditions from another of the multiple color chart images;
for each of the multiple color chart images, the applying of the infrared crosstalk removal calibration comprises determining crosstalk corrected signals:
$${R}_{irsubtract} = R - a \cdot {IR}_{interp} ,$$
$${G}_{irsubtract} = G - b \cdot {IR}_{interp} , and$$
$${B}_{irsubtract} = B - c \cdot {IR}_{interp} ,$$
wherein R is a measured red color chart signal, G is a measured green color chart signal, B is a measured blue color chart signal, a, b, and c are a red crosstalk coefficient, a green crosstalk coefficient, and a blue crosstalk coefficient, respectively, and IRᵢₙₜₑᵣₚ is an interpolation of measured infrared color chart signals;
for each color patch of the color chart, estimating a mean red value, a mean green value, and a mean blue value;
for each gray patch of the color chart, estimating a white-balance gain for the red mean value, a white-balance gain for the mean green value, and a white-balance gain for the mean blue value;
generating a 3×3 color matrix that minimizes a color difference when using the mean red value, the mean green value, and the mean blue value for a respective color patch; and
obtaining at least one of a 4×4 or a 3×4 correction matrix according to:
$$[ \begin{matrix}{c}_{1 , 1} & {c}_{1 , 2} & {c}_{1 , 3} & 0 \\ {c}_{2 , 1} & {c}_{2 , 2} & {c}_{2 , 3} & 0 \\ {c}_{3 , 1} & {c}_{3 , 2} & {c}_{3 , 3} & 0 \\ 0 & 0 & 0 & 1\end{matrix} ] \cdot [ \begin{matrix}{g}_{R} & 0 & 0 & 0 \\ 0 & {g}_{G} & 0 & 0 \\ 0 & 0 & {g}_{B} & 0 \\ 0 & 0 & 0 & 1\end{matrix} ] \cdot [ \begin{matrix}1 & 0 & 0 & - a \\ 0 & 1 & 0 & - b \\ 0 & 0 & 1 & - c \\ 0 & 0 & 0 & 1\end{matrix} ] ,$$
in which C_{m,n} are the m^{th} row, n^{th} column coefficients in the 3×3 color matrix.

8. The method of claim 1, wherein the determining the infrared crosstalk removal calibration comprises computing crosstalk coefficients, and wherein the computing comprises:
obtaining an incremental red signal comprising a difference between a first red signal in the first image and a second red signal in the second image, an incremental green signal comprising a difference between a first green signal in the first image and a second green signal in the second image, and an incremental blue signal comprising a difference between a first blue signal in the first image and a second blue signal in the second image, and an incremental infrared signal comprising a difference between a first infrared signal in the first image and a second infrared signal in the second image; and
determining a red crosstalk coefficient ‘a’ comprising a ratio of the incremental red signal and the incremental infrared signal; determining a green crosstalk ‘b’ coefficient comprising a ratio of the incremental green signal and the incremental infrared signal; and determining a blue crosstalk coefficient ‘c’ comprising a ratio of the incremental blue signal and the incremental infrared signal.

9. The method of claim 1, wherein the first image is captured in a presence of first light and the first light comprises an infrared light.

10. The method of claim 1, wherein the capturing the first image and the second image comprises capturing images of Mᵢ visually neutral flat surfaces from a standard color chart under N lighting conditions, and each of the first image and the second image comprise i zones of image sections;
wherein Mᵢ is 1≤i≤N;
wherein the determining of the infrared crosstalk removal calibration comprises computing crosstalk coefficients, and wherein the computing comprises:
obtaining a reconstructed red signal R_{n,i}, a reconstructed blue signal B_{n,i}, a reconstructed green signal G_{n,i}, and a reconstructed infrared signal IR_{n,i} from at least a first red signal in the first image, a second red signal in the second image, a first green signal in the first image, a second green signal in the second image, a first blue signal in the first image, a second blue signal in the second image, a first infrared signal in the first image, and a second infrared signal in the second image, using interpolation according to:
$$[ \begin{matrix}{R}_{n , 1} & 0 & {I}_{n , 1} & 0 \\ 0 & {B}_{n , 1} & 0 & {I}_{n , 1} \\ & & … & \\ {R}_{n , {M}_{n}} & 0 & {I}_{n , {M}_{n}} & 0 \\ 0 & {B}_{n , {M}_{n}} & 0 & {I}_{n , {M}_{n}}\end{matrix} ] \cdot [ \begin{matrix}{g}_{R , n} \\ {g}_{B , n} \\ {x}_{n} \\ {y}_{n}\end{matrix} ] = [ \begin{matrix}{G}_{1} \\ {G}_{1} \\ … \\ {G}_{n , {M}_{n}} \\ {G}_{n , {M}_{n}}\end{matrix} ]$$
and obtaining crosstalk coefficients a, b, c by obtaining least mean squares according to
$$[ \begin{matrix}- {g}_{R , 1} & 1 & 0 \\ 0 & 1 & - {g}_{B , 1} \\ … & … & … \\ - {g}_{R , N} & 1 & 0 \\ 0 & 1 & - {g}_{B , N}\end{matrix} ] \cdot [ \begin{matrix}a \\ b \\ c\end{matrix} ] = [ \begin{matrix}{x}_{1} \\ {y}_{1} \\ … \\ {x}_{N} \\ {y}_{N}\end{matrix} ] .$$

11. The method of claim 1 further comprising displaying an image corrected by applying the infrared crosstalk removal calibration.

12. The method of claim 1, wherein each of a red signal, a green signal, a blue signal, and an infrared signal is reconstructed from multiple pixel values in the applying of the infrared crosstalk removal calibration.

13. A system to calibrate an RGB-IR image sensor, comprising:
a processor; and
a non-transitory computer-readable medium storing instructions, wherein, when executed by the processor, the instructions cause the system to perform operations comprising:
capturing a first image and a second image with a Red-Green-Blue-infrared (RGB-IR) sensor image sensor;
based at least in part on the first image and the second image, determining infrared crosstalk data between sensor values from the RGB-IR image sensor;
determining an infrared crosstalk removal calibration based at least in part on the determined infrared crosstalk data; and
applying the infrared crosstalk removal calibration to data captured by the RGB-IR image sensor.

14. The system of claim 13, wherein the operations comprise:
computing white-balance removal parameters based at least in part on the data created from the infrared crosstalk removal calibration; and
applying the white-balance removal parameters to the data created from the infrared crosstalk removal calibration.

15. The system of claim 13, wherein the operations comprise operating a camera on a vehicle, and wherein the determined infrared crosstalk removal calibration is applied to each image captured by the camera of the vehicle.

16. The system of claim 13, wherein the RGB-IR sensor comprises multiple pixels, and each pixel produces a red color signal, a green color signal, a blue color signal, and an infrared signal, and the applying of the crosstalk removal calibration removes an infrared component from each of the red color signal, green color signal and blue color signal.

17. The system of claim 13, wherein the first image is captured under a first condition, comprising a presence of a first light to obtain a first red signal, a first green signal, a first blue signal, and a first infrared signal; and
wherein the second image is captured under a second condition by turning off the first light used when capturing the first image to obtain a second red signal, a second green signal, a second blue signal, and a second infrared signal.

18. The system of claim 17, wherein the infrared crosstalk data is determined based at least in part on the first red signal, the second red signal, the first green signal, the second green signal, the first blue signal, the second blue signal, the first infrared signal, and the second infrared signal.

19. A system, comprising:
an RGB-IR image sensor comprising multiple pixels, and each pixel produces a red color signal, a green color signal, a blue color signal, and an infrared signal, wherein the RGB-IR image sensor is configured to:
capturing a first image and a second image with the RGB-IR sensor image sensor;
a crosstalk coefficient calculation unit configured to perform calculations using the first red signal, the second red signal, the first green signal, the second green signal, the first blue signal, the second blue signal, the first infrared signal, and the second infrared signal, wherein the calculations comprise:
determining infrared crosstalk data between sensor values from the RGB-IR image sensor based at least in part on the first image and the second image; and
determining an infrared crosstalk removal calibration based at least in part on the determined infrared crosstalk data; and
applying the infrared crosstalk removal calibration to data captured by the RGB-IR image sensor.

20. The system of claim 19, wherein the system comprises an infrared filter;
wherein the first image is captured in a presence of infrared light without the infrared filter blocking the infrared light; and
wherein the second image is captured with the infrared filter blocking infrared light from the RGB-IR image sensor.
